(19) United States
(12) Patent Application Publication
(10) Pub. No.: US 2010/0324937 A1
(43) Pub. Date: Dec. 23, 2010

(54) METHOD AND SYSTEM FOR CREATING CUSTOMIZED MEDICATION CHARTS

(76) Inventor: Priyanka SRIYAPAREDDY, Noida (IN)

Correspondence Address: General Electric Company;GE Global Patent Operation, 2 Corporate Drive, Suite 648, Shelton, CT, 06484, US

(21) Appl. No.: 12/797,916

(22) Filed: Jun. 10, 2010

(30) Foreign Application Priority Data
Jun. 23, 2009 (IN) 1472/CHE/2009

(51) Int. Cl. G06Q 50/00

(52) U.S. Cl. 705/3

(57) ABSTRACT

A method and system for creating customized medication chart is disclosed herewith. The method comprises: accessing medical information and patient information; and automatically generating a customized medication chart by interpreting the medical information and the patient information. The medication information includes medication information along with dosage and frequency, diagnostics and treatment plans. The patent information includes patient preferences, patient routines and lifestyle information, and patient or user preferences on medication chart display.

### FIELD OF INVENTION

This invention relates generally to management of medication charts indicating medication information and medication schedule and more particularly to, a method and system for creating customized medication charts. The invention is particularly useful in scheduling medication of a patient based on the patient's schedule and prescribed dosage frequency of medication.

### BACKGROUND OF INVENTION

Hospitals in an in-patient setting use medication charts to give medications to a patient for the duration of patients stay in the hospital. Currently, some prior templates or forms are used to create these medication charts. However, these templates or forms are not dynamic and do not take into consideration of schedule or routine of the patient. For example, patients may follow a particular schedule or routine during the course of the day. They might have a set time schedule for eating breakfast, lunch and dinner. Since medications are usually taken before or after eating food, the time for taking these medications need to be related to patient's schedule.

Further, the medication instructions prescribed by the doctor might mention the frequency of dosage such as a specific medication needs to be taken twice or thrice a day. The caretaker or the patient has to do some mental calculations and figure out which medication needs to be taken at what time. This might introduce errors in consuming medication.

In a current hospital workflow, when a patient is admitted to a hospital, the clinician examines the patient and prescribes medicines along with dosage and frequency. The caretaker reads the prescription and interprets the medication before giving the medication to the patient. A medication schedule is calculated and is manually entered into a medication chart. The caretaker manually ensures by continuous follow-ups that the medications are given to the patient, based on the instructions by the clinician. The user schedule is either not considered by the caretaker or the caretaker has to take manual efforts to ensure that medication is given without disturbing the patient's schedule or routine. For example, the caretaker may need to enquire often whether the patient had taken breakfast or lunch. This is prone to errors and after some repeated follow ups, the caretaker may forget about the medication.

Further, currently entering medication information into a medication chart is manual or the information needs to be exported from an external data source and populated into the medication chart by a caretaker. Interpreting the medication instruction is also manual. It is difficult to automate the process of creating medication charts, since each patient has a different schedule.

Further, when a patient gets discharged, he might like to have a medication chart that shows what time he needs to take his medications. For example, a mother might need to take care of administering medications for her three children and her husband who has had surgery recently. Since each of them would be on a different regimen for medication and therapy, she will have to create a different medication chart form for each of her children and husband.

Further it will be beneficial to associate diagnostic treatments such as imaging operations of a patient with the medication chart.

Thus there exist a need to customize a medication chart considering the patient schedule or other relevant information.

### SUMMARY OF INVENTION

The above-mentioned shortcomings, disadvantages and problems are addressed herein which will be understood by reading and understanding the following specification.

One embodiment of the present invention provides a method of preparing medication chart for a patient in a hospital. The method comprises: accessing medical information; obtaining patient information; and automatically generating a customized medication chart by interpreting the medical information and the patient information.

In another embodiment, a computer aided method of preparing a customized medication chart for a patient is disclosed. The method comprises: accessing medication information including medical prescription of a patient; obtaining patient information including patient's daily schedule, routines and display preferences; defining at least one rule based on at least one of the patient information and medication information; deriving a medication schedule using at least one of the defined rules; and generating customized medication chart with the medication schedule and the display preferences.

In another embodiment a medical information management system for managing medication chart of a patient in a hospital is disclosed. The system comprises: a processor; a display in communication with the processor; a memory in communication with the processor for storing and manipulating medication information; and an input device in communication with the processor for receiving patient information. The processor further comprises: an analysis module, configured to analyze the patient information and the medication information for deriving at least one rule; and an implementation module configured to implement the rule to the medication information for generating a customized medication chart.

In yet another embodiment, a machine readable medium or media having recorded thereon instructions configured to instruct a system comprising a computer, memory, and a display, configured to generate a customized mediation chart is disclosed. The media comprises: a routine for defining at least one rule based on patient information and medication information; a routine for deriving a medication schedule using at least one of the defined rules; and a routine for generating customized medical chart with the derived medication schedule and the medication information.

Various other features, objects, and advantages of the invention will be made apparent to those skilled in the art from the accompanying drawings and detailed description thereof.

### BRIEF DESCRIPTION OF THE DRAWINGS

FIG. 1 is a block diagram of a medical information management system as described in an embodiment of the invention;

FIG. 2 illustrates a diagrammatic representation of medication information scheduling system as described in an embodiment of the invention;

FIG. 3 is a flowchart illustrating a method of creating a medication chart as described in an embodiment of the invention;

FIG. 4 is a detailed flowchart illustrating a method of customizing medication chart as described in an embodiment of the invention;

FIG. 5 is a flowchart illustrating a method of creating a customized medication schedule as described in an embodiment of the invention;

FIG. 6 is a flowchart illustrating exemplary workflow with manual interventions in creating a medication chart as described in an embodiment of the invention; and

FIG. 7 is diagrammatic illustration of a medication chart as described in an embodiment of the invention.

### DETAILED DESCRIPTION OF INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block of random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings.

Embodiments of the present invention provide a method and system for generating a customized medication chart. The medication chart is customized considering the patient schedule, routine and life style and displayed according to the preferences set by the patient or a user.

The term “information” referred in the specification need not refer to one parameter, but includes a list of parameters unless otherwise specified. Similarly the term “medication information” and “patient information” need not be limited to the examples mentioned in the specification. Rather, medication information could include any hospital or clinician relevant information and patient information could include any information related to patient.

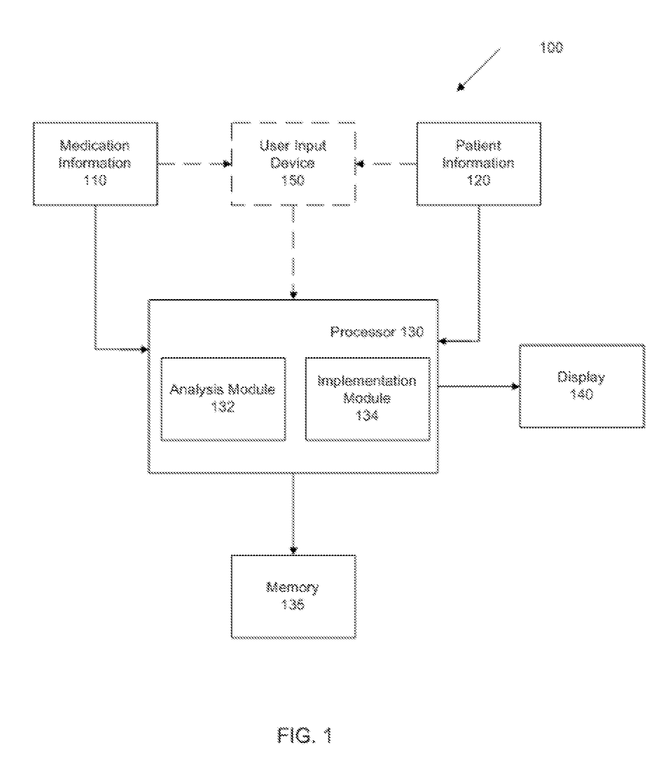

FIG. 1 is a block diagram of a medical information management system as described in an embodiment of the invention. The medical information management system 100 comprises: a processor 130 configured to automatically generate a customized medication chart 150 using medical information 110 and patient information 120. The system may be further provided with a memory 135 and a display 140.

The medical information 110 includes information corresponding to various medications prescribed by a doctor for a patient. In an example, the medical information 110 may include medication information such as name of medicine, strength/dosage, frequency etc. Alternately, the medical information 110 includes treatment plans, details of diagnostic procedure etc. For example, the clinician may suggest an imaging operation after consumption of certain medication for a certain period of time. The patient information 120 may include, the patient routine, schedule, dietary habits or restrictions, lifestyle, habits like exercise etc. The patient information 120 may further include patient or user preference on the medication chart display such as layout, fields required in the display, format etc.

In an embodiment, the processor 130 may be associated with a hospital server or Hospital Information System (HIS). At least part of the patient information 120, and/or the medical information 110 may be fetched from the HIS or a database associated with the hospital server. The processor 130 may include dedicated hardware, software and/or firmware for performing information processing, or a combination of dedicated hardware and software, or software in combination with a general purpose processor, or a digital signal processor. Once the requirements for such software and/or hardware and/or dedicated hardware are gained from an understanding of the descriptions of embodiments of the invention contained herein, the choice of any particular implementation may be left to a hardware engineer and/or software engineer. However, any dedicated and/or special purpose hardware or special purpose processor is considered subsumed in the block labeled processor 130.

The medical information 110 may be directly fed to the processor 130 or to its associated from a database or a caretaker may manually input the medical information 110. The processor 130 further comprises an analysis module 132. Many times the clinician prescribes medication, dosage and frequency in particular format and that need to be interpreted.

In an embodiment, the analysis module 132 interprets the medical information 110. The analysis module 132 comprises a predefined set of instructions that could be used to interpret the medical information 110. Alternately, the analysis module 132 could include a look up table based on which the medical information 132 is interpreted. Analysis module 132 further uses medical information 110 and patient information 120 in identifying a suitable rule. For example, the analysis module 132 may interpret the medication information 110 and analyze the patient information 120 such as his schedule and a proper rule may be identified to derive an optimal medication schedule. The processor further comprises an implementation module 134. The implementation module 134 implements the rule identified by the analysis module 132 and automatically generate a customized medication chart. The medication chart is prepared by considering the patient information 120 and the medical information 110. The implementation module 134 generates an optimal schedule for the medication considering the patient schedule and preferences.

The processor further includes the memory 135. The memory 135 may include, for example, random access memory (RAM), flash memory, or read-only memory. For purposes of simplicity, devices that can read and/or write media on which computer programs are recorded are also included within the scope of the term “memory.”

In an embodiment, the patient information may be fed to the processor 130 or the memory 135 associated with it using a user input device 150. The user input device 150 may also be used to input caretaker/patient preference such as mode of display, format, layout etc. In an embodiment, the medication information 110 and patient information 120 could be provided using the user input device 150. In an example, the user input device 150 could include a mouse, a touch screen and stylus, a keyboard with cursor keys, or combinations thereof.

The system 100 further includes a display 140. The medication chart may be displayed in the display. The display 140 may include audio or visual display. The display 140 in communication with the processor 130 may display some alarms indicating the optimal schedule for medication.

In an embodiment, a user or caretaker may intervene the automated process using the user input device 150. Further, in the event of a conflict between the patient schedule and medication frequency suggested by the clinician, a caretaker may overwrite the rule and the schedule for administering medication may be set by the caretaker.

In an embodiment, a diagnostic procedure may be scheduled based on the patient convenience or based on his daily schedule. For example, the clinician may prescribe for an ultrasound scan and the scanning may be scheduled based on at least one of the hospital resource availability, patient schedule including habits and any other treatment or diagnostic procedures. Based on one or more of the available information, the diagnostic operation may be planned without disturbing the patient schedule. Further, while preparing the schedule, dietary requirements and timings of the meal may be included in the schedule.

In some embodiment, the medication information management system 100 can comprise software or firmware instructing a computer to perform certain actions. Some embodiments of the present invention comprise stand-alone workstation computers that include memory, a display, and a processor. The workstation may also include a user input interface.

In an embodiment, the medication chart is generated in real time. The chart may be refreshed at a periodic interval updating the time at which last medication is administrated, any change in the patient schedule, any diagnostic procedure etc.

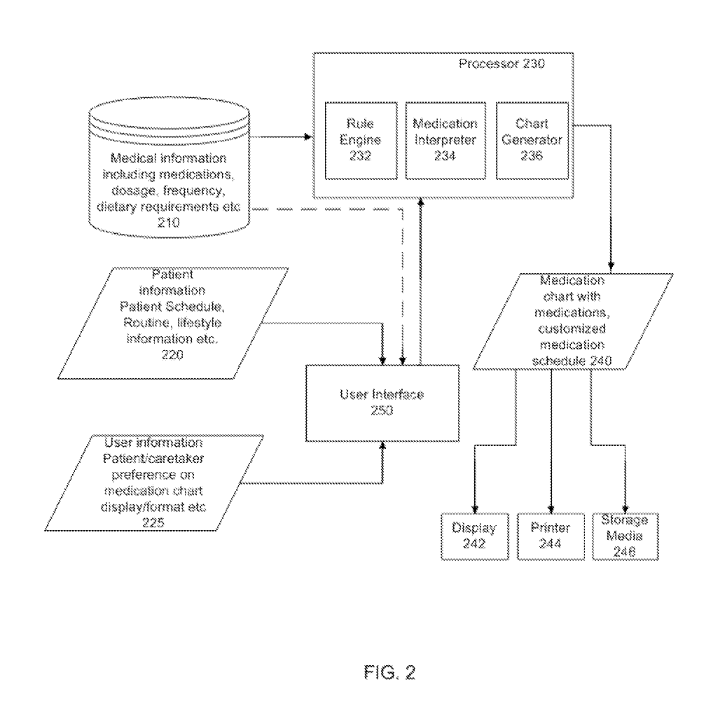

FIG. 2 illustrates diagrammatic representation of medication information scheduling system as described in an embodiment of the invention. Medication information 210 corresponding to a patent includes name of medicine, strength/dosage, frequency of medicine etc. The medication information 210 may be available in a database. The medication information 210 may be populated to the database by a clinician or caretaker. The medication information 210 may be automatically fetched or may be populated to the medication information scheduling system using a user input device 250.

Patient information 220 is considered in customizing a medication chart 140. The patient information 220 includes patient schedule like schedule for eating breakfast, lunch and dinner, sleeping time, patient's lifestyle like smoking habits or routines such as exercising schedule. Further, patient information 220 may comprise user information 225 including the patient or caretaker preference on the medication chart 140 may be provided. For example, a patient may need to generate an alarm such as a window popping up on the patient or caretaker's computer screen to alarm the patient indicating the time of medication. The user or the patient may have different preferences on the appearance and features of the medical chart 240 and these preferences may also be populated via the user input device 250. In an embodiment shown, the patient information 220 and user information 225 are provided through the user input device 250.

In an embodiment, the user information 225, helps the users or patients to change the layout and design the medication charts as per their convenience. Alternately, the patient may select the preferred language in which the medication chart needs to be displayed. This helps the user to interpret the medication charts 240 easily since it is custom tailored for their use. Medication chart 240 can be customized for view for a day, a week or longer. User information facilitates the user to define his own graphic symbols that could be displayed in the medication chart next to the medication. These graphic symbols could be used to represent the method of dosage, quantity of dosage and dosage instruction next to the medication name in the medication chart 240. Time Lines on the medication chart 240 can be configured for change. The user can set it to show a chart with hourly intervals, or quarterly intervals as well as what needs to be displayed on the x-axis and what needs to be displayed on the y-axis.

The processor 230 further includes a medication interpreter 232 configured to interpret the medication information 210. Many times the clinician might prescribe the medication information 210 in the form of medical instructions expressed using clinical or medical terminology. Clinicians may have different styles and that need to be interpreted manually or electronically. In an embodiment, known algorithms are used to interpret the medication information.

In an example, the clinician may prescribe the medication in a paper or in an electronic workflow as “Aspirin and p.o b.i.d”. The medication information 210 is fed to the medication interpreter 232 manually in case of a paper prescription or automatically in case of an electronic prescription. The medical instruction interpreter 232, interprets the medical instruction such as p.o b.i.d. In an example, the p.o b.i.d. may be interpreted as “take the medication orally twice a day”.

The processor 230 includes a rule engine 234 configured to have different set of rules that could be used in generating customized medication chart. The rule engine 234 may contain a set of rules or lookup table and based on the patient information 220 and/or medication information 210, the rule engine 234 may select some rules. The rule engine 234 uses the medication information 210 and the patient information 220 along with the user information 225 in identifying an appropriate rule. For example, patient information 220 may suggest patient's exercise schedule and a rule may be generated or selected to avoid the duration of exercise for administering medication. In an embodiment, some of the rules present in a rule engine 234 may assist the medical instruction interpreter 232 in interpreting the medication information 220. In an embodiment, rules could handle some exceptions, which need not be related to time. For example, during the course of some medication, consumption of alcohol should be avoided and this could be added as an exception, though not related to time.

The processor 230 further includes a chart generator 236 that automatically generates the medication chart 240 based on the rule identified by the rule engine 234. The patient or user in the user information 225 may specify his preferences on the medication chart display such as parameters that needs to be displayed, style etc. The chart generator 236 based on the user information and using the rule identified by the rule engine 234 generates the medication chart 240.

Different parts of the processor 230 such as medication interpreter 232, rule engine 234, chart generator 236 etc may be hardware, software and/or firmware, or a combination of dedicated hardware and software. Different parts may be combined to a single unit or module and implemented.

The medication chart 240 may be displayed in a display 242. In an embodiment, the display 242 may be located both with the patient and the caretaker. Further the display 242 may generate an alarm based on the customized schedule.

The medication chart 240 may be sent to a printer 244 for printing and may be saved in a storage medium 246 including any electronically readable media. A non-exhaustive list of media that can be read with such a suitable device includes CDs, CD-RWs, DVDs of all types, magnetic media (including floppy disks, tape, and hard drives), flash memory in the form of sticks, cards, and other forms, ROMs, etc., and combinations thereof. In an embodiment, the medication chart may be handed over to the patient upon discharge and he may still use the same medication chart. If appropriate support is provided, patient or hospital authorities may update the medication chart even after the patient being discharged from the hospital.

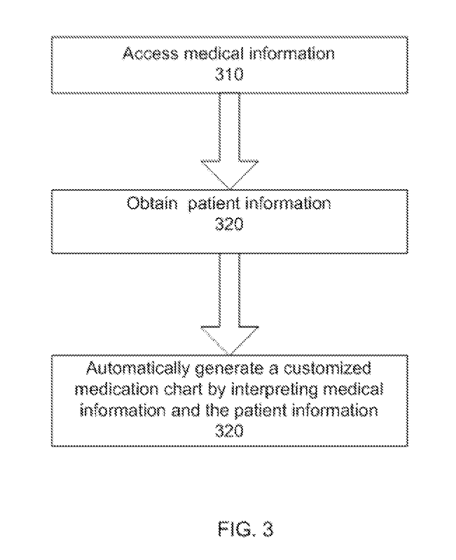

FIG. 3 is a flowchart illustrating a method of creating a medication chart as described in an embodiment of the invention. At step 310, medical information is accessed. The medical information could be accessed from a hospital information system, hospital server, or database or any external server or database. Alternately, a user or clinician may populate the medication information from a database or a paper prescription. The medical information could be accessed manually or electronically. The medical information could include details of medicines, dosage, frequency etc. Medical information may be prescribed in an electronic or a paper prescription. The prescription may have different medical instructions, which need to be interpreted to understand the medical information. The medical term may be interpreted by a caretaker manually or certain instruction or algorithms may be used to interpret the medical term automatically. At step 320, patient information is accessed. The patient information includes patient schedule, habits, routines etc. The patient information may be checked with the patient and populated manually. Alternately, at the time of admission of a patient to a hospital this information may be obtained from the patient and may be saved in a database. The patient information could further include patient or caretaker or user preference on the display of the medication chart. At step 330, a customized medication chart is generated based on the medical information and the patient information. The customized medication chart includes an optimal time schedule derived based on the medical information and patient schedule. The display of the medication chart is set based on the user or patient preference. For example, a medication schedule is prepared based on the medications prescribed by the clinician and the patient's schedule and convenience. This will facilitate scheduling a medication, without disturbing the patient's daily routine or other schedules.

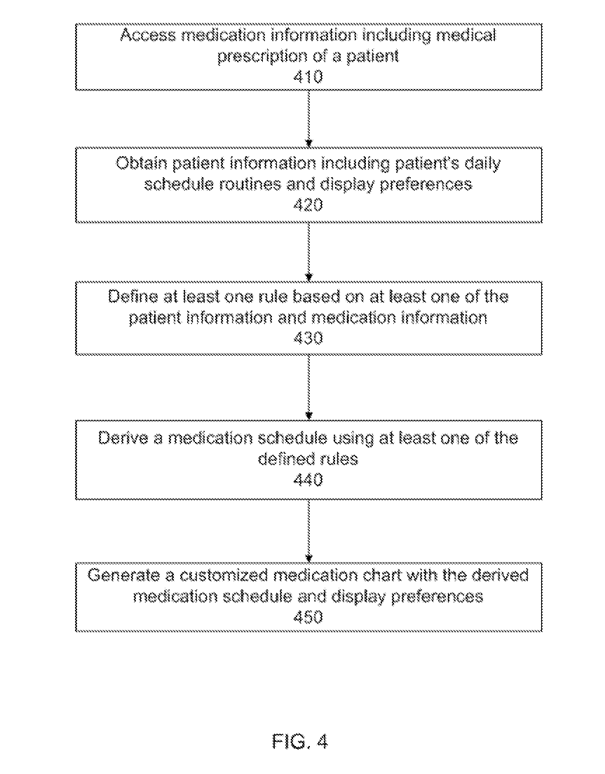

FIG. 4 is a detailed flowchart illustrating a method of customizing medication chart as described in an embodiment of the invention. At step 410, medication information is accessed from a medical prescription or a database. The medication information includes medications, dosage and frequency of medication. The step 410 further comprises interpreting the medication information. While interpreting, a time bound medication activity suggested by the clinician may be identified from the medication information. Examples of the time bound activity may include “consume the medication twice a day after food” or “check the glucose level before and after breakfast”. At step 420, patient information is obtained. The patient information includes patient details along with his daily schedule and his preference on the display of the medication chart. The patient information may be accessed from a database or could be obtained from the patient. At step 430, at least one rule is defined based on the medication information or the time bound medication activity identified from the medication information and the patient schedule obtained from the patient information. Based on the time bound activity and patient schedule, a rule is selected. For example, the time bound activity identified from the medication information may be “check the glucose level before and after breakfast” and the patient schedule may suggest that patient generally has his breakfast at 8.00 am. Based on this information, a rule like “set a time before and after 8.00 am for glucose level checking” may be identified. At step 440, a medication schedule is derived using the identified rule. The identified rule is applied over the medication information and patient information and an optimal medication schedule is derived. The schedule might indicate that “ proceed with glucose level checking at 7.30 am and 8.30 am”. At step 450, a customized medication chart is generated using the derived medication schedule and display preference given by the patient or the user. The display parameter may include features like formatting, visual appearances etc. The chart may communicate with a display to generate alarms at 7.30 am and 8.30 am.

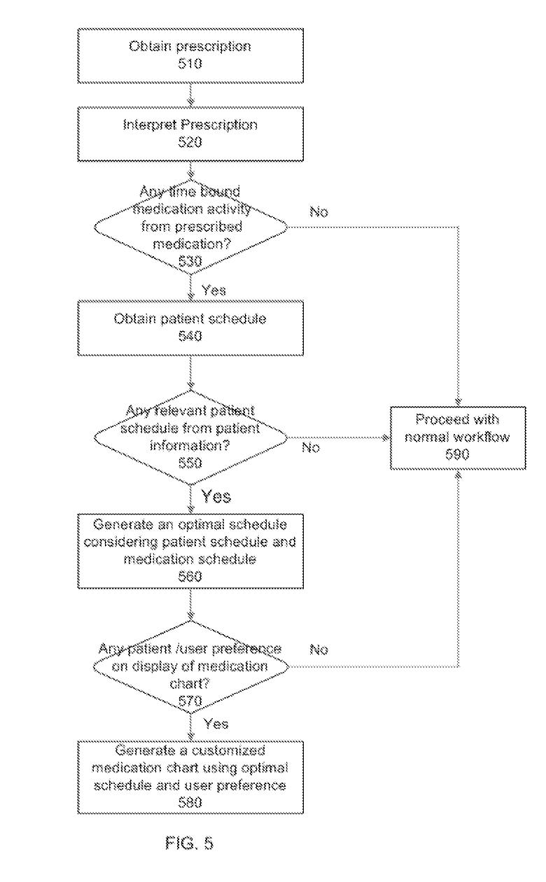

FIG. 5 is a flowchart illustrating a method of creating a customized medication schedule as described in an embodiment of the invention. At step 510, medical prescription is obtained. At step 520, the medical prescription is analyzed an interpreted. Frequency and dosage of medication is identified. At step 530, a check is made to verify any time bound medication activity is identified while interpreting the medical prescription. If no time bound medication activity is identified, the method may follow the normal workflow as at step 590. At step 540, patient information is obtained. Patient information includes his schedule information along with patient/user preferences on the medication chart display. At step 550, a check is made to verify whether any patient relevant schedule is identified from the patient information. In the absence of any relevant schedule, the method may follow the normal workflow as indicted at step 590. At step 560, an optimal schedule is generated based on the patient schedule and the time bound activity identified. At step 570, a check is made to identify any patient or user information is provided about the display of medication chart. If yes, a customized medication chart is displayed with the desired display settings suggested by the patient or the user, as at step 580. In the absence of any preference suggestion, medication chart is displayed normally with the optimal schedule, using the normal workflow, as at step 590.

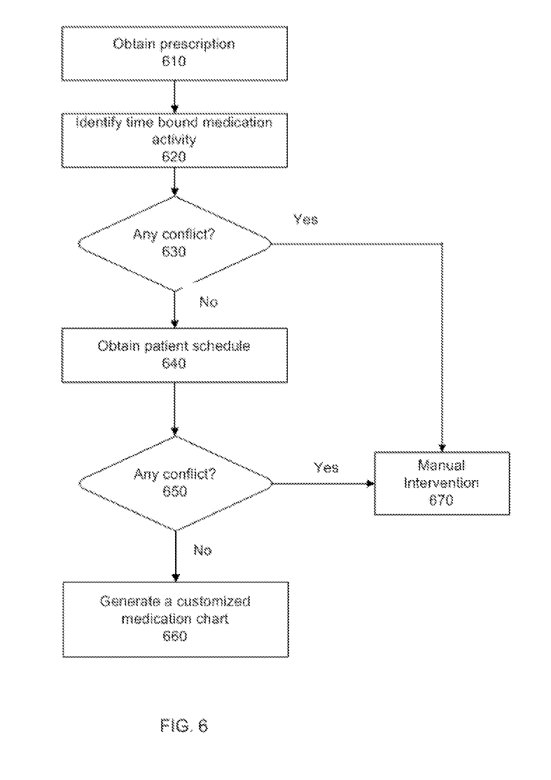

FIG. 6 is a flowchart illustrating exemplary workflow with manual interventions in creating a medication chart as described in an embodiment of the invention. At step 610, prescription having medication, frequency and dosage information is accessed. At step 620, a time bound medication activity is identified by analyzing the prescription. For example, the prescription may suggest that take medicine “Rantac” before food. At step 630, a check is made for any conflict. For example, there are some medicines that could cause acidity, if taken in empty stomach. So caretaker may suggest taking some light food before having the medication. Thus in the event of a conflict, manual intervention is done as shown at step 670. The manual intervention may overwrite the existing rule and create a new rule to define the medication schedule. At step 640, patient information is accessed. The patient information includes patient schedules, routines, habits, dietary restrictions etc. At step 650, a check is made for any conflict. For example, patient's schedule may suggest that patient will have acidic problem, if any medication is taken in empty stomach. If any conflict is identified, caretaker manually schedules the medication, as at step 670. In the absence of any conflict, a customized medication schedule may be generated based on the patient schedule and time bound activity suggested by the prescription as at step 660.

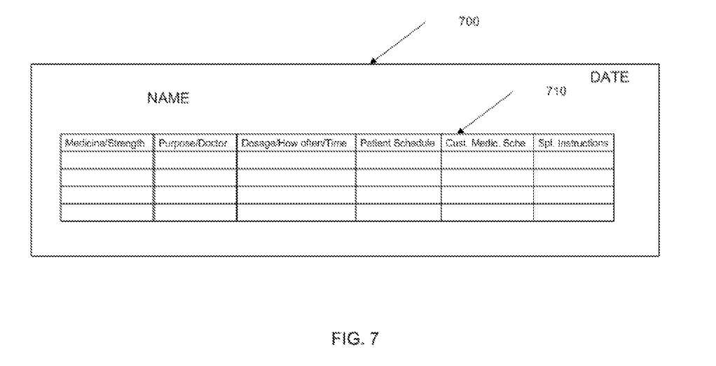

FIG. 7 is diagrammatic illustration of an automated medical chart as described in an embodiment of the invention. The medication chart 700 indicates various parameters such as patient name, medicines, the clinician's name, dosage, frequency, patient schedule and customized medication schedule 710 indicating the time of administration of medication calculated in relation to the patient information.

In yet other embodiments of the present invention, a machine readable medium or media may include, but not limited to, magnetic disks and diskettes, optical disks and diskettes, and/or ROM, flash ROM, and/or battery backed RAM, or any other suitable magnetic, optical, or electronic medium or media. The medium (or media) has recorded thereon instructions configured to instruct a system that includes a computer, memory, and a display. The instructions include instructions for defining at least one rule based on patient information and medication information. The media further includes instructions for deriving a medication schedule using at least one of the defined rules and generating customized medical chart with the derived medication schedule and the medication information. This will create a personalized medication chart.

However software and/or firmware (hereinafter referred to generically as “software”) can be used to instruct the computer to perform the inventive combination of actions described herein. Further, in some embodiments, this may comprise one or more electronic hardware components or special-purpose hardware components that may be configured to perform the same purpose as a software module or to aid in the performance of the software module.

Some of the advantages of the invention include reducing the manual efforts in creating medication charts, resulting in reduced medication errors. Further, since the medication charts created are customized for a user, it requires less effort for the user to understand and interpret the medication chart and helps the patients who use personal health records to create their own customized medication charts. Thus the overall quality of the patient care will be increased considerably.

The above-description of the embodiments of the methods and systems has the technical effect automatically generating a customized medication chart based on medication information and patient information.

As used herein, an element or step recited in the singular and proceeded with the word “a” or “an” should be understood as not excluding plural elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property. Moreover, the terms “computer” and “processor” are used interchangeably herein to refer to either specialized hardware to perform digital signal processing, control, data manipulation, and/or calculations, or a general purpose computer that can be programmed to perform the same functions and/or adapted to interface with external digital signals. The phrases “computer or processor” and “processor or computer” are therefore intended to have equal scope with either of the individual terms and are not intended to imply a dichotomy between the two terms.

Exemplary embodiments are described above in detail. The assemblies and methods are not limited to the specific embodiments described herein, but rather, components of each assembly and/or method may be utilized independently and separately from other components described herein. Further the steps involved in the workflow need not follow the sequence in which there are illustrated in figures and all the steps in the work flow need not be performed necessarily to complete the method.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

What is claimed is:

1. A computer aided method of preparing a customized medication chart for a patient comprising:
accessing medication information including a medical prescription of a patient;
obtaining patient information including the patient's daily schedule, routines and display preferences;
defining at least one rule based on at least one of the patient information and medication information;
deriving a medication schedule using at least one of the defined rules; and
generating and outputting a customized medication chart with the medication schedule and the display preferences.

2. The method as claimed in claim 1, wherein the step of accessing medication information comprises: interpreting by medication interpreter physician prescribed dosage and frequency for intake of medication from the medical prescription.

3. The method as claimed in claim 2, wherein the step of accessing medication information further comprises: identifying a time bound medication activity from the medication information.

4. The method as claimed in claim 1, wherein the step of deriving the medication schedule comprises: defining a customized medication schedule based on time bound medication activity from the medical prescription and the patient's daily schedule.

5. The method as claimed in claim 1, further comprising: rendering the customized medical chart in an electronic display and medium.

6. A medical information management system for managing medication chart of a patient in a hospital comprises:
a processor;
a display in communication with the processor;
a memory in communication with the processor for storing and manipulating medication information; and
an input device in communication with the processor for receiving patient information;
wherein the processor is configured to perform a method comprising:
accessing medication information including a medical prescription of a patient;
obtaining patient information including the patient's daily schedule, routines and display preferences;
defining at least one rule based on at least one of the patient information and medication information;
deriving a medication schedule using at least one of the defined rules; and
generating and outputting a customized medication chart with the medication schedule and the display preferences.

7. The system as claimed in claim 6 further comprising an analysis module configured to analyze the patient's daily schedule and prescribed medications.

8. The system as claimed in claim 7 further comprising an implementation module configured to derive a medication schedule based on the patient's daily schedule and prescribed medications.

9. The system as claimed in claim 7 further comprising an implementation module configured to generate a customized medication chart with the derived medication schedule and the medication information.

10. A machine readable medium comprising instructions which, when executed by a machine, cause the machine to perform operations to instruct a system comprising a computer, memory, and a display, configured to generate a customized mediation chart, wherein the operations comprise:
defining at least one rule based on patient information and medication information;
deriving a medication schedule using at least one of the defined rules; and
generating customized medical chart with the derived medication schedule and the medication information.
